(19) United States
(12) Patent Application Publication
(10) Pub. No.: US 2011/0094099 A1
(43) Pub. Date: Apr. 28, 2011

(54) METHOD FOR MANUFACTURING COPPER CLAD ALUMINIUM BUS BAR

(76) Inventor: Xishan Yang, Liao Ning (CN)

(21) Appl. No.: 11/568,874

(22) PCT Filed: Apr. 28, 2005
(86) PCT No.: PCT/CN2005/000585

§ 371 Date: Oct. 21, 2008

(51) Int. Cl. H01R 43/16

(52) U.S. Cl. 29/874

(57) ABSTRACT

A processing method of a copper-clad aluminum bus-bar includes the following steps: selecting a copper pipe and an aluminum bar, and removing the oxide skins of the the copper pipe internal hole and the aluminum bar excircle by mechanically scrubbing; then putting them into the protective gas to prepare for assembly, inserting the aluminum bar into the copper pipe in the protective gas and closing the two ends to prevent from the air; heating the body with closed-ends in the heating-furnace and preventing them from being oxidized; drawing them to form metallurgical combination; rolling the finished bus-bar rough into copper-clad aluminum bus-bar conductors with different sizes in the rolling mill. The copper-cladaluminum bus-bar combines the two defined conductive metals, copper and aluminum, into one conductor, thereby provides a: lower cost and lighter weight conductor than fine copper conductor under the situation of guaranteeing its reliability. It is very considerable in saving of the material and labor cost. Its cost is lowest, saving 30% to 50%, and it is considered as an environmental conservation product because of saving a mass of copper resource. The density of the fine copper bus-bar is 8.9 g/cm³, which is 3.47 times higher than that of the copper-clad aluminum bus-bar, which is 3.63 g/cm³, and the copper-clad aluminum bus-bar is 3.47 times longer than the fine copper bus-bar with same weight and width.

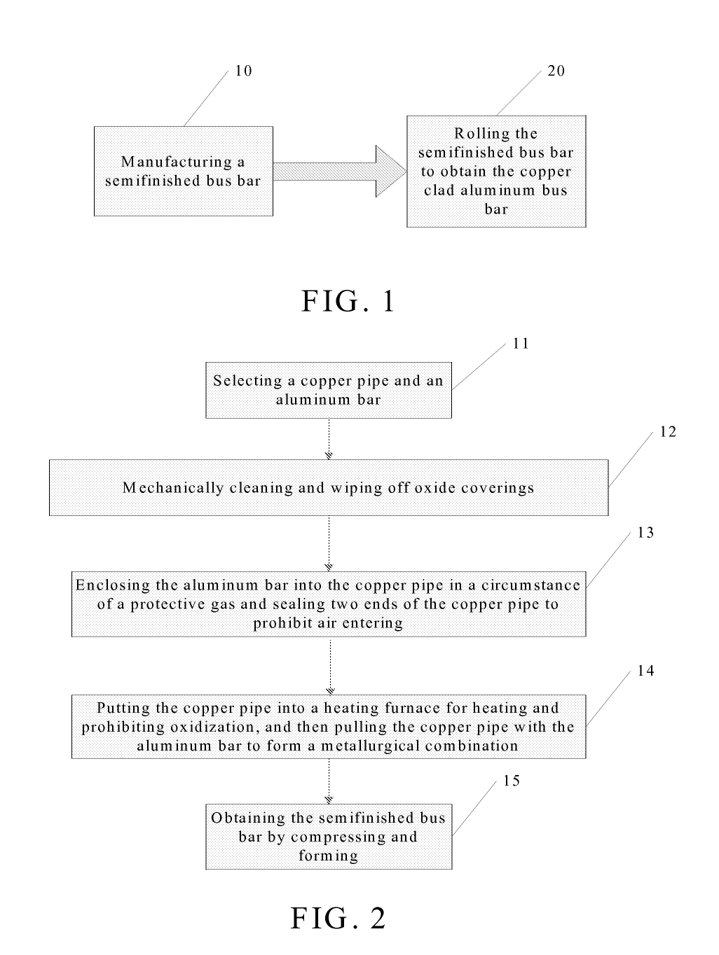

### BACKGROUND OF THE PRESENT INVENTION

1. Field of Invention

The present invention relates to methods for manufacturing bus bars, particularly to a copper clad aluminum (CCA) bus bar.

2. Description of Related Arts

Conventional copper bus bars have advantages of a fine electrical conductivity, a small resistivity, a big mechanical strength, a good anticorrosion performance, and so on. However, the copper bus bars have disadvantages of an expensive price, a heavy weight, a high cost, so that it is limited to using of the copper bus bars. Though aluminum bus bars have a low cost, the aluminum bus bars can't satisfy requirements. Copper clad aluminum bus bars can combine the advantages of the copper bus bars and the aluminum bus bars. Though the copper clad aluminum bus bar has a structure similar to the copper bus bar and the aluminum bus bar, the copper clad aluminum bus bar needs a different manufacturing method. What is needed, is to provide a method for manufacturing a copper clad aluminum bus bar.

### SUMMARY OF THE PRESENT INVENTION

In order to solve the above problems, the present invention provides a method for manufacturing copper clad aluminum bus bar. The main object of the present invention is to utilize the advantages of both copper and aluminum, integrate these two conductive metals to form a conductor, which has the same reliability but a better performance in economy and weight than pure copper. Another object of the present invention is to replace the pure copper bus bars using in high end electric devices such as low voltage distributor, switch boards, motor control center, dashboard, bus box, elevated busway system, high voltage distributor, vacuum switchgear, generating set, transformer, rectifier, motor winding, fuse and crane power supply system.

A method for manufacturing a copper clad aluminum bus bar of the present invention includes a process for manufacturing a semifinished bus bar, and a process for rolling the semifinished bus bar to obtain the copper clad aluminum bus bar by using a rolling mill. The process for manufacturing a semifinished bus bar includes a step for selecting a copper pipe and an aluminum bar, a step for mechanically cleaning the copper pipe and the aluminum bar to wipe off oxide coverings, a step for enclosing the aluminum bar into the copper pipe in a circumstance of a protective gas, and sealing two ends of the copper pipe with the aluminum bar thereinto to prohibit air entering, a step for putting the copper pipe with the aluminum bar thereinto into a heating furnace to heating and prohibiting oxidization, and then pulling the copper pipe with the aluminum bar thereinto to form a metallurgical combination, and a step for obtaining the semifinished bus bar by compressing and forming.

In one embodiment, the step of mechanically cleaning includes using steel brushes to wipe off the oxide coverings at an inner surface of the copper pipe and an out surface of the aluminum bar under the steel brushes rounding with a high speed. Each quarter circle of the aluminum bar is equipped with one of the steel brushes. The steel brush utilized to cleaning the inner surface of the copper pipe is a helix steel brush, and the step of mechanically cleaning the inner surface of the copper pipe is finished by the helix steel brush slipping in the copper pipe.

In another embodiment, the protective gas is argon.

In still another embodiment, the step of enclosing the aluminum bar into the copper pipe is acted by a special pushing device, and the copper pipe and the aluminum bar are a slip match.

In still another embodiment, the step of sealing includes adding two end caps onto the two ends respectively, and using an argon arc welding to joint the two end caps with the two ends respectively.

In still another embodiment, a temperature in the step of heating is selected from 600° C. to 660° C.

In still another embodiment, the step of pulling includes pulling the copper pipe with the aluminum bar thereinto to form the metallurgical combination with a predetermined external diameter.

In still another embodiment, the rolling mill is a hole rolling mill. The hole rolling mill comprises at least one roll, and each roll acts a compressing.

In still another embodiment, the copper clad aluminum bus bar has a density of 3.63 grammes per cubic centimeter. The copper clad aluminum bus bar has a tensile strength over 130 Mpa. The copper clad aluminum bus bar has a resistivity of 0.0265 Ω mm2/m at a temperature of 20° C.

The manufacture principle: it is using solid heating pressure forming method, applying heat and pressure for plastic deformation, to close the distance of the interface of the two metals to atom distance. A large amount of connection points are formed. After diffusion heat treatment, the bonding of the interface is formed.

The present method for manufacturing a copper clad aluminum bus bar is utilized to obtain the copper clad aluminum bus bar. The copper clad aluminum bus bar has advantages of the copper bus bar and the aluminum bus bar. The copper clad aluminum bus bar has a cost lower 30% to 50% of a cost of the copper bus bar. The copper clad aluminum bus bar has a density of 3.63 grammes per cubic centimeter, and the copper bus bar has a density of 8.9 grammes per cubic centimeter, so that the copper clad aluminum bus bar is lighter than the copper bus bar with a same length.

### DETAILED DESCRIPTION OF THE PREFERRED EMBODIMENT

Reference will now be made to the drawings to describe a preferred embodiment of the present thermal switch, in detail.

In the present invention, a method for manufacturing a copper clad aluminum bus bar includes a process for manufacturing a semifinished bus bar, and a process for rolling the semifinished bus bar to obtain the copper clad aluminum bus bar by using a rolling mill. The process for manufacturing a semifinished bus bar, includes a step for selecting a copper pipe with an external diameter of 20 to 70 micrometers and an aluminum bar with a corresponding size, a step for mechanically cleaning the copper pipe and the aluminum bar to wipe off oxide coverings, a step for enclosing the aluminum bar into the copper pipe in a circumstance of a protective gas, and sealing two ends of the copper pipe with the aluminum bar to prohibit air entering, a step for putting the copper pipe with the aluminum bar into a heating furnace for heating and prohibiting oxidization, and then pulling the copper pipe with the aluminum bar to form a metallurgical combination, and a step for obtaining the semifinished bus bar by compressing and forming.

In a first embodiment, the step of mechanically cleaning includes using steel brushes to wipe off the oxide coverings at an inner surface of the copper pipe and an out surface of the aluminum bar under the steel brushes rounding with a high speed. Each quarter circle of the aluminum bar is equipped with one of the steel brushes. The steel brush utilized to clean the inner surface of the copper pipe is a helix steel brush, and the step of mechanically cleaning the inner surface of the copper pipe is finished by the helix steel brush slipping in the copper pipe. The protective gas is argon. The step of enclosing the aluminum bar into the copper pipe is acted by a special pushing device, and the copper pipe and the aluminum bar are a slip match. The step of sealing includes adding two end caps onto the two ends respectively, and using an argon arc welding to join the two end caps with the two ends respectively. Temperature in the step of heating is selected from 660° C. The step of pulling includes pulling the copper pipe with the aluminum bar to form the metallurgical combination with a predetermined external diameter. The hole rolling mill comprises at least one roll, and each roll acts a compressing.

In a second embodiment, the method for manufacturing a copper clad aluminum bus bar is very similar to the method of the first embodiment. In the second embodiment, the step of mechanically cleaning includes using steel brushes to wipe off the oxide coverings at an inner surface of the copper pipe and an out surface of the aluminum bar under the steel brushes rounding with a high speed. Each quarter circle of the aluminum bar is equipped with one of the steel brushes. The steel brush utilized to clean the inner surface of the copper pipe is a helix steel brush, and the step of mechanically cleaning the inner surface of the copper pipe is finished by the helix steel brush slipping in the copper pipe. The protective gas is argon. The step of enclosing the aluminum bar into the copper pipe is acted by a special pushing device, and the copper pipe and the aluminum bar are a slip match. The step of sealing includes adding two end caps onto the two ends respectively, and using an argon arc welding to join the two end caps with the two ends respectively. Temperature in the step of heating is selected from 600° C. The step of pulling includes pulling the copper pipe with the aluminum bar to form the metallurgical combination with a predetermined external diameter. The hole rolling mill comprises at least one roll, and each roll acts a compressing.

In a third embodiment, the method for manufacturing a copper clad aluminum bus bar is very similar to the method of the first embodiment. In the third embodiment, the step of mechanically cleaning includes using steel brushes to wipe off the oxide coverings at an inner surface of the copper pipe and an out surface of the aluminum bar under the steel brushes rounding with a high speed. Each quarter circle of the aluminum bar is equipped with one of the steel brushes. The steel brush utilized to clean the inner surface of the copper pipe is a helix steel brush, and the step of mechanically cleaning the inner surface of the copper pipe is finished by the helix steel brush slipping in the copper pipe. The protective gas is argon. The step of enclosing the aluminum bar into the copper pipe is acted by a special pushing device, and the copper pipe and the aluminum bar are a slip match. The step of sealing includes adding two end caps onto the two ends respectively, and using an argon arc welding to joint the two end caps with the two ends respectively. Temperature in the step of heating is selected from 640° C. The step of pulling includes pulling the copper pipe with the aluminum bar to form the metallurgical combination with a predetermined external diameter. The hole rolling mill comprises at least one roll, and each roll acts a compressing.

What is claimed is:

1. A method for manufacturing a copper clad aluminum bus bar, comprising:
a process for manufacturing a semifinished bus bar, which comprises a step for selecting a copper pipe and an aluminum bar, a step for mechanically cleaning the copper pipe and the aluminum bar to wipe off oxide coverings, a step for enclosing the aluminum bar into the copper pipe in a circumstance of a protective gas, and sealing two ends of the copper pipe with the aluminum bar thereinto to prohibit air entering, a step for putting the copper pipe with the aluminum bar into a heating furnace for heating and prohibiting oxidization, and then pulling the copper pipe with the aluminum bar to form a metallurgical combination, and a step for obtaining the semifinished bus bar by compressing and forming; and
a process for rolling the semifinished bus bar to obtain the copper clad aluminum bus bar by using a rolling mill.

2. The method as claimed in claim 1, wherein the step of mechanically cleaning comprising using steel brushes to wipe off the oxide coverings at an inner surface of the copper pipe and an out surface of the aluminum bar under the steel brushes rounding with a high speed.

3. The method as claimed in claim 2, wherein each quarter circle of the aluminum bar is equipped with one of the steel brushes.

4. The method as claimed in claim 2, wherein the steel brush utilized to clean the inner surface of the copper pipe is a helix steel brush, and the step of mechanically cleaning the inner surface of the copper pipe is finished by the helix steel brush slipping in the copper pipe.

5. The method as claimed in claim 1, wherein the protective gas is argon.

6. The method as claimed in claim 1, wherein the step of enclosing the aluminum bar into the copper pipe is acted by a special pushing device, and the copper pipe and the aluminum bar are a slip match.

7. The method as claimed in claim 1, wherein the step of sealing comprising adding two end caps onto the two ends respectively, and using an argon arc welding to join the two end caps with the two ends respectively.

8. The method as claimed in claim 1, wherein a temperature in the step of heating is selected from 600° C. to 660° C.

9. The method as claimed in claim 1, wherein the step of pulling comprising pulling the copper pipe with the aluminum bar to form the metallurgical combination with a predetermined external diameter.

10. The method as claimed in claim 1, wherein the rolling mill is a hole rolling mill.

11. The method as claimed in claim 10, wherein the hole rolling mill comprising at least one roll, and each roll acts a compressing.

12. The method as claimed in claim 1, wherein the copper clad aluminum bus bar has a density of 3.63 grammes per cubic centimeter.

13. The method as claimed in claim 1, wherein the copper clad aluminum bus bar has a tensile strength over 130 Mpa.

14. The method as claimed in claim 1, wherein the copper clad aluminum bus bar has a resistivity of 0.0265 Ω mm²/m at a temperature of 20° C.
